(19) United States
(12) Patent Application Publication
(10) Pub. No.: US 2016/0279472 A1
(43) Pub. Date: Sep. 29, 2016

(54) Smart Fitness Adapter

(71) Applicant: Michael William Johnston, Athens, GA (US)

(72) Inventor: Michael William Johnston, Athens, GA (US)

(21) Appl. No.: 15/067,527

(22) Filed: Mar. 11, 2016

Related U.S. Application Data
(60) Provisional application No. 62/138,371, filed on Mar. 25, 2015.

(51) Int. Cl. A63B 24/00; G09B 19/00; A63B 21/062

(52) U.S. Cl. CPC A63B 24/0062; A63B 21/062; G09B 19/003; A63B 24/0003

(57) ABSTRACT

Various embodiments of methods and systems for apparatus monitoring are disclosed wherein the apparatus is associated with fitness equipment for humans.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on Mar. 25, 2015, and assigned Ser. No. 62/138,371 which application is incorporated herein by reference in its entirety.

### FIELD

The present disclosure relates to a device and system for use of fitness equipment and/or fitness tracking.

### BACKGROUND

Fitness trackers are revolutionizing the way health and fitness are being monitored. Within recent years many types of wearable trackers have become available to the consumer. These trackers are usually worn around the wrist, on the belt/hip, or attached to the person by some other means. They are capable of collecting a wide range of information about the wearer's daily activities and then will transmit it to an external device for analysis. The information these types of devices can provide about the standard workout or exercise regimen is limited by their attachment to the user, and not the equipment. This limits them to collecting data on only the motion of the device and certain biometric information about the wearer.

Many forms of exercise equipment have built-in data collection mechanisms. Such machines may include treadmills, elliptical machines, or other cardiovascular / endurance training equipment. The type of data these machines record is often the same as those recorded by wearable fitness trackers. Most strength training equipment does not have any type of built in data collection. As a result, most machines that utilize a cable to transfer resistance do not provide any type of feedback to the user.

### SUMMARY

The present disclosure includes an apparatus that is attached to fitness equipment or is otherwise used with equipment to provide information about the equipment's use. The apparatus may be configured to gather and/or collects fitness data that may not already be collected by the equipment through an internal or built in system. The apparatus may be attached to and/or otherwise used with fitness equipment. The apparatus may be used with and/or tethered to fitness equipment that utilizes a cable and/or weight stack to provide resistance to a human user of the fitness equipment.

In another embodiment, the apparatus is configured to collect data about the equipment's fitness equipment use and/or transmit such data to a module operatively linked to the apparatus. In another embodiment, the apparatus may comprise or be configured to comprise of one or more types of force detection, data storage capacity and/or electronic data transmission. The apparatus may also contain additional sensors such as one or more accelerometers to provide motion information and/or one or more radio frequency identification sensors so the apparatus may determine to which machine it is connected to and/or tethered to and/or in use with.

In an embodiment, the apparatus may be configured to be utilized with equipment comprising a weight stack and/or cable. In an embodiment, the apparatus may comprise three embodiments. for cable attachment and/or for weight stack use and/or for a combination of cable attachment and weight stack use.

In an embodiment, the apparatus may tethered to fitness equipment by a cable for attachment, using one or two connection points at either end of the end of the apparatus. In this manner the invention is interposed between a user at one end of a cable and a weight stack. The apparatus may be attached or mounted to the cable by e.g., a hook or loop at the end of the cable. In this manner, the user can attach a bar, rope or other form of handle to the apparatus by a second cable. Thus the apparatus invention may be attached between the cable and handle. The apparatus can then gather data about the equipment's use as the forces exerted on the handle are transmitted through the apparatus to the cable which cable is then attached to a fitness equipment, or apparatus, e.g., a weight stack.

In another embodiment, if the apparatus is to be used on equipment that has a weight stack, it can be inserted into the weight stack in place of a standard lifting pin. When the equipment is used, the forces that are normally exerted on the lifting pin will instead be exerted on the apparatus. The apparatus will detect these forces and collect information about the equipment's use.

In another embodiment, the apparatus may be configured for both cable connection and weight stack insertion or connection. In this embodiment, the lifting pin portion, or rod, may be detachable so as not to interfere with the user when the apparatus is tethered via cable to the user and/or fitness equipment.

### BRIEF DESCRIPTION OF THE DRAWINGS

FIG. 1 is a schematic diagram of the apparatus as configured for use connected in line with cabled fitness equipment. The apparatus is shown enlarged on the left and on the right in use it a standard setup for cable connection.

FIG. 2 is a schematic of the apparatus as configured for use with equipment that uses a weight stack. The apparatus is shown enlarged on the left and in use in a standard setup for weight stack insertion.

FIG. 3 is a schematic of the apparatus as configured for both cable connected and weight stack use. The apparatus is shown on top with the rod connected to the invention. The apparatus is shown at the bottom with the rod detached.

FIG. 4 is a high-level functional block diagram illustrating an exemplary architecture of a system for apparatus monitoring.

FIG. 5 is a functional block diagram illustrating an exemplary, non-limiting aspect of a portable computing device (“PCD”) in the form of a wireless telephone for implementing monitoring of the apparatus.

FIG. 6 is a schematic diagram illustrating an exemplary software architecture for apparatus use embodiments.

### DETAILED DESCRIPTION

Aspects, features and advantages of several exemplary embodiments of the apparatus, systems and methods will become better understood with regard to the following description in connection with the accompanying drawing(s). It will be apparent to one of ordinary skill in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, any use of absolute terms such as, for example, “will,” “will not,” “shall,” “shall not,” “must” and “must not” are not meant to limit the scope of the disclosure as the particular embodiments disclosed herein are merely exemplary.

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” “processing component” and “chip” are used interchangeably. Moreover, a CPU, DSP, GPU or chip may be comprised of one or more distinct processing components generally referred to as “core(s).”

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, a remote AP package associated with a user, among others.

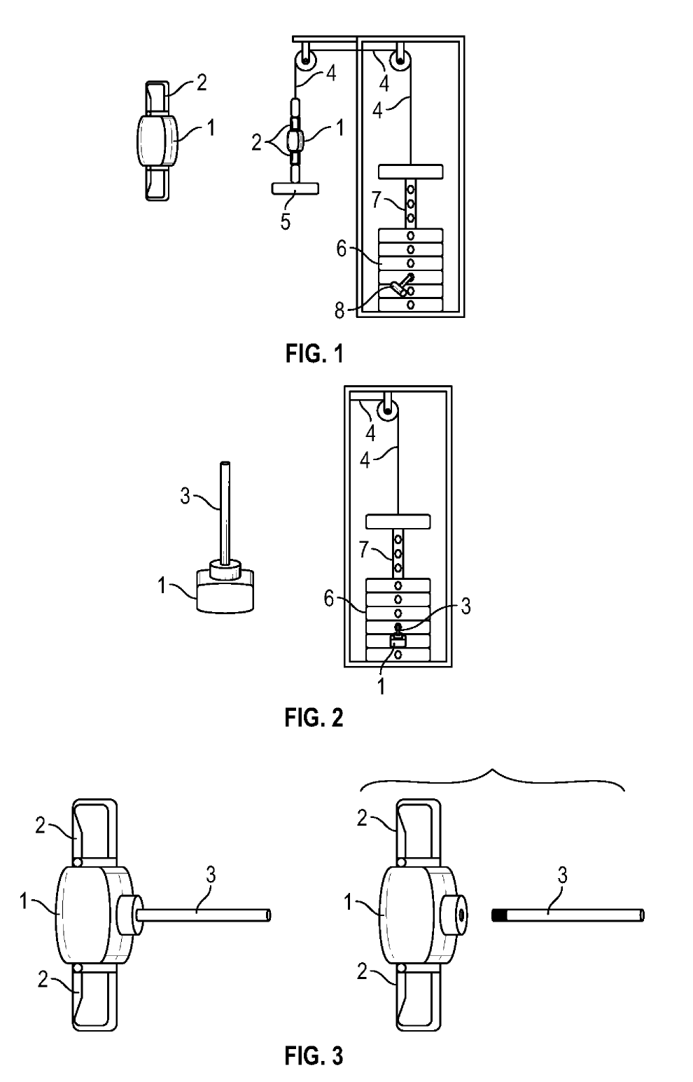

With reference to FIG. 1, the apparatus may be connected with fitness equipment that uses a cable to transmit resistance. In this embodiment, the apparatus 100 is connected to cable 4 and handle 5 by the two connection points 2 on either end of the apparatus. When the fitness equipment is in use, forces are transmitted through the apparatus. These forces are measured and recorded in the body 1 of the apparatus, e.g., by a strain gauge enclosed within the apparatus body 1. The body 1 of the apparatus is essentially the same for all three designs. The body 1 of the apparatus contains measuring sensors to determine the forces applied and hardware to collect and/or save this data. The body 1 also contains a way to transmit data to an external device, such as a wireless transmitter or connection ports. The body 1 may also contain a radio frequency identification system so the apparatus can identify the equipment it is being used with. Additionally, the body 1 may contain or enclose other data collection devices such as accelerometers to gather data about the motion of the device.

With reference to FIG. 2, the apparatus may be configured for connection with equipment that uses a weight stack 6 to provide resistance. This type of equipment is generally comprised of a stack of weights 6 that are connected to a central lifting column 7 by a lifting pin 8. When the column 7 is inserted into the weight stack 6, the amount of weight connected to the column can be adjusted by moving the lifting pin 8 to an appropriate hole to provide the desired resistance. In this embodiment, the apparatus replaces the standard lifting pin 8. The rod 3 of the apparatus is inserted into the weight stack and through the lifting column 7 in place of the standard lifting pin 8. Sensors in the rod 3, e.g., a strain or compression guage, detects forces applied to the lifting column and weights and transmits such electronic data to other modules in the apparatus.

With reference to FIG. 3, the apparatus may be configured for both applications shown in FIG. 1 and FIG. 2. This configuration can be used for cabled connection or inserted into a weight stack. When designed for both applications the rod 3 is detachable. The detachability of the rod 3 is demonstrated in FIG. 3).

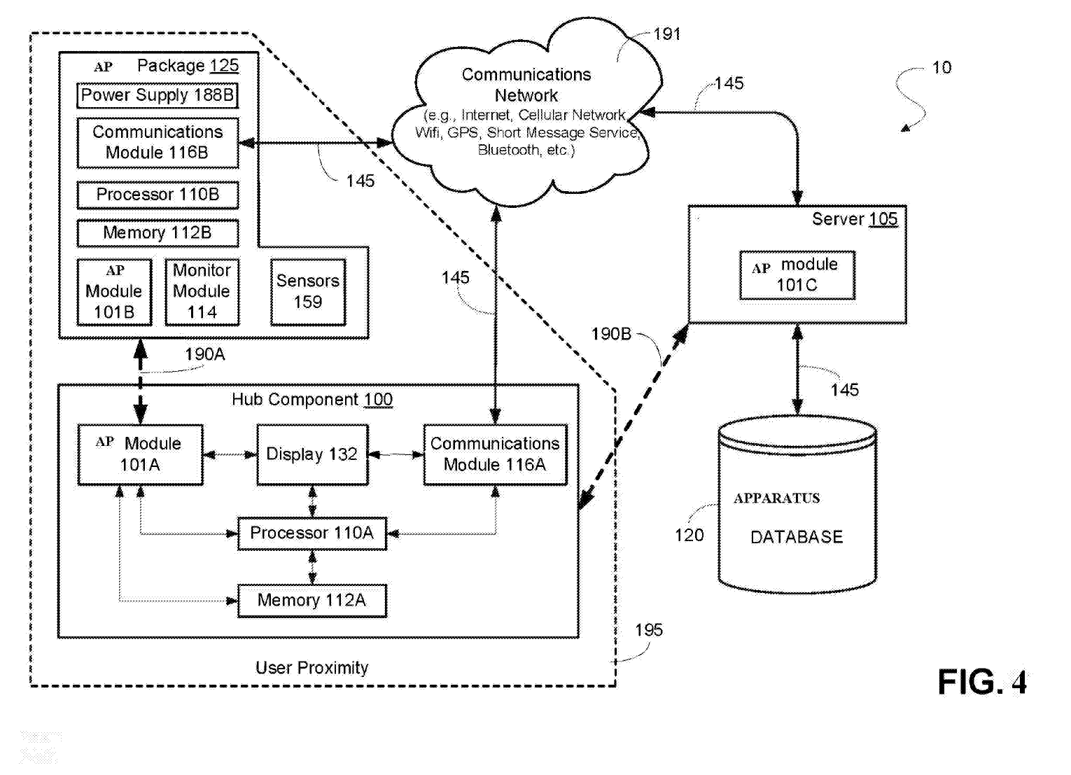

Turning now to FIG. 4, illustrated is a high level functional block diagram of an exemplary architecture of a system 10 for apparatus monitoring (“AP”). A user proximity 195 includes a hub component 100 in the form of a portable computing device and an AP package 125. The AP package is generally enclosed by apparatus 1. The user proximity 195 envisions an AP package 125 in wireless communication via link 190A with a hub component 100 that is in the vicinity of a user. For example, a user using the apparatus package 125 and carrying a portable computing device 100, such as a Smartphone, on his person would be one example of the hub component 100 and the apparatus package 125 being within the user proximity 195. Another example of the hub component 100 and the apparatus package 125 being within the user proximity 195 would include the apparatus package 125.

Notably, although the FIG. 4 illustration depicts an apparatus package 125 and a hub component 100 within a common user proximity 195, it will be understood that not all embodiments of an AP system and method require a hub component 100 and an apparatus package 125 to be within a user proximity. That is, it is envisioned that certain functionality in an AP embodiment may be implemented via a remote computing device such as an apparatus server 105. In such embodiments, the apparatus package 125 may communicate with the apparatus server 105 via a communications network 191 without need to communicate 190A with a hub device 100. In other embodiments, an apparatus package 125 may communicate with either or both of the apparatus server 105 and the hub component 100. Similarly, in some embodiments, the hub component 100 may transmit data to and/or from the apparatus server 105 via link 190B which is implemented over communications network 191.

In the FIG. 4 illustration, the apparatus package 125 is shown to include a power supply 188B for powering the apparatus package 125, a communications module 116B for establishing communications with either or both of hub component 100 and apparatus server 105 via communications network 191, a processor 110B and a memory 112B. The apparatus package 125 also is shown to include sensors 159 (such as may include any combination of a strain gauge, a compression gauge, a stretching gauge, an accelerometer, a GPS transceiver, etc.), monitor module 114B for monitoring the sensors 159 and apparatus module (“AP”) 101B for processing readings from sensors 159 according to AP algorithms.

Similar to the apparatus package 125, the hub component 100 includes a communications module 116A for transmitting and/or receiving communications over network 191 from apparatus server 105 and/or apparatus package 125, a processor 110A, a memory 112A and an AP or apparatus module 101A. The hub component 100 also is shown to include a display 132 for rendering one or more outputs to an AP user. The apparatus server 105 is also depicted as including an AP or apparatus module 101C.

Notably, not all of the components depicted in the FIG. 4 illustration are required in all AP embodiments. That is, it is envisioned, for example, that a certain AP embodiment may include just a single AP or apparatus module 101A in a hub component while other embodiments include AP or apparatus modules 101 in each of the apparatus package 125, the hub component 100, and/or the apparatus server 105. As such, it will be understood from the FIG. 1 illustration that all of certain module, or a portion of a certain module, may or may not reside in a certain component of an AP system.

As described above, the apparatus package 125 may be worn by a user such that sensors 159 monitor certain physiological and/or non-physiological parameters associated with the user. Notably, although not shown in the FIG. 1 illustration, it is envisioned that certain sensors, such as an accelerometer, may reside within hub component 100 in some embodiments. The monitor module 114 monitors the sensors 159 and forwards the collected data to the AP or apparatus module 101B according to instructions dictated by the AP or apparatus module 101B. For example, the AP or apparatus module 101B may receive accelerometer readings from an accelerometer in sensors 159 and, based on the accelerometer readings, determine that the apparatus package 125 is stable in motion. The AP or apparatus module 101B may subsequently instruct the monitor module 114 to record and forward a pulse oximetry reading.

The data generated by the sensors 159, collected by the monitor module 114 and managed by the AP or apparatus module 101B may be stored locally in the memory 112B of the apparatus package 125 and/or transmitted to the hub component 100 and/or the apparatus server 105. Once received by the hub component 100 and/or the apparatus server 105, the AP or apparatus modules 101A, 101C may use the data to generate other AP outputs. Notably, it is envisioned that certain AP embodiments may be comprised completely within an apparatus package 125, while other AP embodiments may utilize a very streamlined apparatus package 125 including only those components needed for collecting sensed data and transmitting to other components in the system.

In certain AP embodiments, data generated by sensors 159 and transmitted to apparatus server 105 may be stored in a database 120 for later download and utilization. Similarly, it is envisioned that either or both of apparatus package 125 and hub component 100 may include an apparatus database 120 in their respective memories 112.

The exemplary embodiments of a hub component 100 and apparatus package 125 envision remote communication, real-time software updates, extended data storage, etc. and may be leveraged in various configurations by users of system 10. Advantageously, embodiments of hub components 100 and/or apparatus packages 125 configured for communication via a computer system such as the exemplary system 10 depicted in FIG. 1 may leverage communications networks 191 including, but not limited to cellular networks, PSTNs, cable networks, WiFi and the Internet for, among other things, software upgrades, content updates, database queries, data transmission, etc. Other data that may be used in connection with a hub component 100 and/or apparatus package 125, and accessible via the Internet or other networked system, will occur to one of ordinary skill in the art.

The illustrated computer system 10 may comprise an apparatus server 105 that may be coupled to a network 191 comprising any or all of a wide area network (“WAN”), a local area network (“LAN”), the Internet, or a combination of other types of networks. It will be understood that the term server 105 may refer to a single server system or multiple systems or multiple servers. The server 105 may be coupled to an apparatus database 120, as described above. The apparatus database 120 may store various records related to, but not limited to, historical sensor reading data, apparatus algorithms, filters/rules algorithms, user preferences, previously calculated apparatuss, trends, etc.

When the server 105 is coupled to the network 191, the server 105 may communicate through the network 130 with various different hub components 100 and apparatus packages 125 associated AP users. Each hub component 100 and/or apparatus package 125 may run or execute web browsing software or functionality to access the server 105 and its various AP applications including AP module 101C. Any device that may access the network 191 either directly or via a tether to a complimentary device, may be a hub component 100 or apparatus package 125 according to the computer system 10. The hub component 100 or apparatus package 125, as well as other components within system 10 such as, but not limited to, a wireless router (not shown), may be coupled to the network 191 by various types of communication links 145. These communication links 145 may comprise wired as well as wireless links. The communication links 145 allow a hub component 100 or apparatus package 125 to establish virtual links 190 with the server 105 and/or each other. While a virtual link 190B, for example, is depicted between the server 105 and the hub device 100, an actual wired or wireless link 145 may exist between the server 105 and the hub device 100. This link 145 may only be used to relay data to the APPARATUS server 105 from hub component 100 or apparatus package 125, depending on embodiment, as a uni-directional communications channel. In other exemplary embodiments, the APPARATUS server 105, hub component 100 and/or apparatus package 125 may establish bi-directional communications over network 191 as understood by one of ordinary skill in the art.

As shown, the hub component 100 may include a display 132, a processor 110A and a communications module 116A that may include one or more of a wired and/or wireless communication hardware and a radio transceiver 117. It is envisioned that the display 132 may comprise any type of display device such as a liquid crystal display (“LCD”), a plasma display, an organic light-emitting diode (“OLED”) display, a touch activated display, and a cathode ray tube (“CRT”) display, a brail display, an LED bank, and a segmented display. A hub component 100 may execute, run or interface to a multimedia platform that may be part of a plug-in for an Internet web browser.

The communications module 116 may comprise wireless communication hardware such as, but not limited to, a WiFi card or NFC card for interfacing with APPARATUS module 101. Further, the communications module 116 may include a cellular radio transceiver to transmit collected physiological and/or non-physiological data as well as other information to other components, as depicted in the system 10 embodiment. One of ordinary skill in the art will recognize that a communications module 116 may include application program interfaces to processor 110.

It is envisioned that a hub component 100 and/or apparatus package 125 may be configured to leverage the cellular radio transceiver of the communications module 116 to transmit data, such as physiological data by way of a secure channel using wireless link 190. Communication links 145, in general, may comprise any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network.

An exemplary hub component 100 and/or apparatus package 125 may also comprise a computer readable storage/memory component 112 for storing, whether temporarily or permanently, various data including, but not limited to, physiological readings and apparatus calculations.

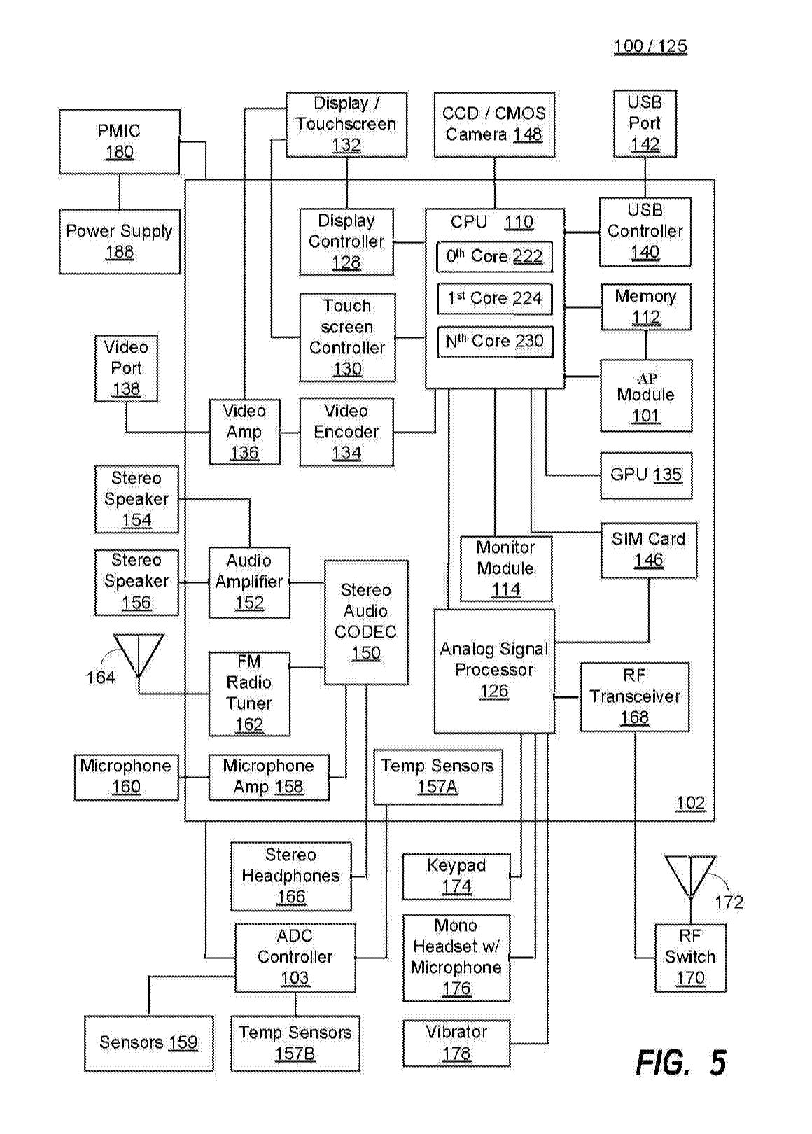

FIG. 5 is a functional block diagram illustrating an exemplary, non-limiting aspect of a portable computing device (“PCD”), such as a hub component 100 and/or an AP package 125, for implementing apparatus monitoring (“AP”) methods and systems. The PCD may be in the form of a wireless telephone in some AP embodiments. As shown, the PCD 100, 125 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, apparatus (“AP”) module 101 may be formed from hardware and/or firmware and may be responsible for determining when certain sensor readings should be taken and calculating a fitness according to one or more apparatus algorithms. It is envisioned that apparatus algorithms in some AP embodiments may be customizable by a user.

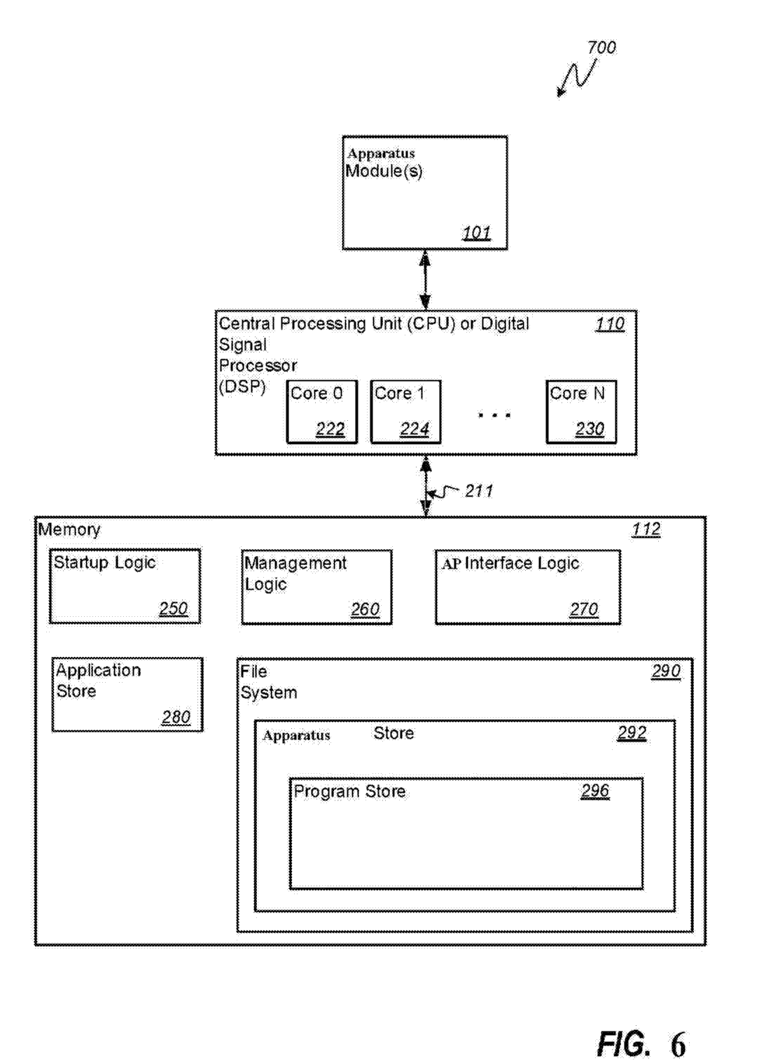

As illustrated in FIG. 5, a display controller 128 and a touch screen controller 130 are coupled to the digital signal processor 110. A touch screen display 132 external to the on-chip system 102 is coupled to the display controller 128 and the touch screen controller 130. PCD 100, 125 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 6, a universal serial bus (“USB”) controller 140 is coupled to the CPU 110. Also, a USB port 142 is coupled to the USB controller 140. A memory 112, which may include a PoP memory, a cache 116, a mask ROM/Boot ROM, a boot OTP memory, a DDR memory 115 may also be coupled to the CPU 110. A subscriber identity module (“SIM”) card 146 may also be coupled to the CPU 110. Further, as shown in FIG. 6, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 6, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 6 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 5 further indicates that a radio frequency (“RF”) transceiver 168 may be coupled to the analog signal processor 126. An RF switch 170 may be coupled to the RF transceiver 168 and an RF antenna 172. As shown in FIG. 6, a keypad 174 may be coupled to the analog signal processor 126. Also, a mono headset with a microphone 176 may be coupled to the analog signal processor 126. Further, a vibrator device 178 may be coupled to the analog signal processor 126. FIG. 6 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source. In another particular aspect, the power supply 188 includes a kinetically rechargeable DC battery.

The CPU 110 may also be coupled to one or more internal, on-chip thermal sensors 157A as well as one or more external, off-chip thermal sensors 157B and physiological sensors 159. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

FIG. 6 is a schematic diagram illustrating an exemplary software architecture 700 for continuous transdermal monitoring (“AP”) embodiments. As illustrated in FIG. 7, the CPU or digital signal processor 110 is coupled to the memory 112 via main bus 211. The memory 112 may reside within a hub component 100, an AP package 125 or a combination thereof. Similarly, it will be understood that the AP module 101 and the CPU 110 may reside within a hub component 100, an AP package 125 or a combination thereof.

The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores.

The CPU 110 may receive commands from the apparatus module(s) 101 that may comprise software and/or hardware. If embodied as software, the module(s) 101 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art and described above in the definitions. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100, 125 is implemented in software, as is shown in FIG. 7, it should be noted that one or more of startup logic 250, management logic 260, AP interface logic 270, applications in application store 280 and portions of the file system 290 may be stored on any computer-readable medium for use by, or in connection with, any computer-related system or method. In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), Flash, and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the AP interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for identifying accurate physiological sensor readings and/or generating an output. The startup logic 250 may identify, load and execute a select AP program. An exemplary select program may be found in the program store 296 of the embedded file system 290. The exemplary select program, when executed by one or more of the core processors in the CPU 110 may operate in accordance with one or more signals provided by the AP module 101 to identify accurate physiological sensor readings and/or generate an output.

The management logic 260 includes one or more executable instructions for terminating an AP program on one or more of the respective processor cores, as well as selectively identifying, loading, and executing a more suitable replacement program. The management logic 260 is arranged to perform these functions at run time or while the PCD 100 is powered and in use by an operator of the device. A replacement program, which may be customized by a user in some AP embodiments, may be found in the program store 296 of the embedded file system 290.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the weight of parameters used to generate a customized output.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD 100, 125 to search, locate, modify or replace the startup logic 250, the management logic 260, applications in the application store 280 and information in the embedded file system 290. The operator may use the resulting interface to make changes that will be implemented upon the next startup of the PCD 100, 125. Alternatively, the operator may use the resulting interface to make changes that are implemented during run time.

The embedded file system 290 includes a hierarchically arranged apparatus store 292. In this regard, the file system 290 may include a reserved section of its total file system capacity for the storage of information for the configuration and management of the various AP algorithms used by the PCD 100, 125.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

We claim:

1. An apparatus for monitoring human activity using a fitness device comprising at least one connecting member wherein the connecting member is operatively engaging the fitness device and wherein the apparatus is configured to capture and/or transmit data corresponding to the engagement of the fitness device.

2. The apparatus according to claim 1 wherein the apparatus is operatively joined to a load on the fitness device. The apparatus according to claim 2 wherein the apparatus is tethered to the load by a cable.

4. The method according to claim 4 wherein the load is a one or more weight plates.

5. The apparatus according to claim 2 further comprising a rod configured to engage the load.

6. The apparatus according to claim 5 wherein the load is one or more weight plates.
